(19) United States
(12) Patent Application Publication
(10) Pub. No.: US 2008/0116742 A1
(43) Pub. Date: May 22, 2008

(54) Brake modulation device and method

(76) Inventor: Mark C. Lipski, Mineola, TX (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/820,906

(22) Filed: Jun. 21, 2007

Related U.S. Application Data
(60) Provisional application No. 60/860,132, filed on Nov. 20, 2006.

(51) Int. Cl. B60T 17/08; B60T 1/06; F17D 3/00; B60T 17/00

(52) U.S. Cl. 303/87; 137/1; 188/18 A; 303/1

(57) ABSTRACT

A brake modulation device is provided, the device being configured to be installed in a vehicle's brake system. The brake modulation device includes a housing having an internal bore, outer threads, and a passageway extending from the outer surface of the housing to the internal bore, the internal bore containing brake fluid. The brake modulation device also includes a cap, adapted to be fastened to the housing and retain a primary seal. The cap defines a chamber therein, the chamber holding a compressible gas. The primary seal provides a barrier between brake fluid in the brake system, and the compressible gas held within the chamber. A secondary seal may be provided between the cap and the housing.

### RELATED APPLICATION

The present application claims the benefit of U.S. Provisional Application No. 60/860,132 filed Nov. 20, 2006, which is incorporated herein in its entirety by reference.

### TECHNICAL FIELD

The present invention relates to vehicle braking systems. More particularly, the present invention relates specifically to a brake modulation device and method of modulation a brake system.

### BACKGROUND OF THE INVENTION

Conventional hydraulic brake systems used in motor vehicles, such as automobiles, all-terrain vehicles (ATV's), motorcycles, snowmobiles, typically comprise drum brakes or disc brakes. Drum brakes utilize a source of hydraulic pressure to actuate a piston to bias a brake shoe having a friction material surface into contact with a brake drum. Disc brakes utilize a source of hydraulic pressure to actuate a piston to bias a piston to move a brake pad containing friction material into contact with a vertical face of a rotor. Because of the out-of-roundness inherent in brake drums and of the lateral run out inherent in rotors, the friction element alternately engages low and high spots on the brake drum or rotor. Because of the relative incompressibility of the brake fluid the pressure in the brake system experiences a sharp increase when the friction element engages a high spot on the drum or rotor and experiences a relative pressure decrease when the friction element rubs a low spot on a drum or rotor. These pressure fluctuations which occur in the brake fluid cause pressure waves, surges, spikes and harmonics to propagate through the hydraulic system, thereby decreasing performance of the system.

Typically, a pressure wave would move from a wheel cylinder or disk brake piston to the brake master cylinder and thereafter be reflected back from the master cylinder to the wheel cylinder or brake caliper piston. Very high momentary braking pressures occur within the hydraulic system when the reflected pressure waves, surges, spikes and harmonics moving toward the brake cylinder or piston add to clamping force already exerted thereon.

In common vehicle hydraulic brake systems one or more wheels of the vehicle may lock or skid during severe braking applications while the other wheels are rotating which may cause the vehicle operator to experience a loss of control. It may be demonstrated that wheel lockup occurs because a friction element becomes “stuck” on a so called high spot on a disk brake drum or rotor. This wheel lockup occurs because the high spot initiates a high pressure wave into the hydraulic system which moves from a wheel cylinder or brake piston towards the master cylinder and reflects back through the brake line and adds to the clamping force already exerted on the shoe or caliper. In addition, wheel lockup may occur because of a traction differential at two or more of the tires, due to adverse road conditions such as snow, ice, sand, gravel, etc.

Consequently, it has been found that the addition of a small accumulator to the hydraulic system will absorb pressure surges to maintain a constant fluid pressure at each actuator piston and thereby reduce the tendency of a friction element to prematurely become “stuck” on a brake drum or rotor high spot.

Previous solutions to the problem of reducing wheel lock-up typically rely on the use of accumulators. Such accumulators typically function to reduce pressure surges within a vehicle brake system, and they suffer a number of disadvantages. To begin with, the devices are not universally applicable to all vehicle hydraulic systems. As an example, the hydraulic brake system for a motorcycle contains a small volume of fluid compared to the volume of brake fluid in an automobile or truck or bus hydraulic system. Thus, a different accumulator must be manufactured for each of these systems. Additionally, the accumulators do not discriminate between vehicles which are heavy or light in weight, vehicles which carry a large percentage of their weight on the front of the vehicle as opposed to the rear of the vehicle and high performance vehicles such as racing cars which have different braking requirements than conventional passenger cars. Accumulators must be custom made for each application. Also, in the past it has been difficult to obtain an accumulator which will provide the optimum amount of brake pedal pressure or the optimum amount of brake travel required during the braking process. Additionally, prior accumulators have been unable to provide a desired feel of the brake pedal or feedback from the brake pedal to the operator during the brake process in vehicle brake system with accumulator. In some vehicle applications the brake pedal may feel spongy whereas in other vehicle applications the brake pedal may feel very stiff to an operator after an accumulator has been installed. Also, in some vehicle applications a relatively large amount of brake pedal travel occurs whereas in other applications very little brake travel occurs as a result of the addition of an accumulator within the vehicle hydraulic system. Furthermore, neither of the aforementioned previous accumulator devices provides a simple means of adjusting the device to obtain a desired or proper brake pedal feel or amount of travel.

In certain accumulator-type devices, their addition to a vehicle hydraulic brake system requires that the accumulator device must be initialized prior to obtaining proper operation thereof. Such an initialization requires that a vehicle operator make several severe braking applications or panic stops subsequent to installation of the device. This initialization must occur each time the integrity of the hydraulic system is disturbed.

From the above, it may be seen to be desirable to provide a pressure control device for a vehicle hydraulic brake system which may be adjusted readily to provide an optimum brake pedal feel and travel amount for any desired vehicle, which does not require an initialization process subsequent to installation which may be utilized in vehicles having large or small volume hydraulic systems, which will accommodate light or heavy vehicles or vehicles which have a greater percentage of vehicle weight on one end of the vehicle or the other, which will work satisfactorily on high performance vehicles and which maintains a more constant brake pedal feel and amount of travel without regard to temperature influence.

### SUMMARY OF THE INVENTION

In one embodiment, the present invention comprises a brake modulation device configured to be installed in a vehicle's brake system. The brake modulation device includes a housing having an internal bore, outer threads, and a passageway extending from the outer surface of the housing to the internal bore, the internal bore containing brake fluid. The brake modulation device also includes a cap, adapted to be fastened to the housing and retain a primary seal. Cap defines a chamber therein, the chamber holding a compressible gas. The primary seal provides a barrier between brake fluid in the brake system, and the compressible gas held within the chamber. A secondary seal may be provided between the cap and the housing.

In another embodiment, the brake modulation device may also be provided with an adjustment mechanism, to adjust the performance of the vehicle's brake system. A set screw may be included in the cap, the set screw being in communication with the chamber, such that the set screw may be advanced into or out of the chamber to adjust the pressure of the compressible gas within the chamber. Further, characteristics of the primary seal may be modified in order to alter the modulation effect. For example, the thickness, stiffness, material type, or durometer rating of the primary seal may be changed to alter the modulation effect.

The brake modulation device may be installed in a number of applications, and installed in a number of ways. The device is suitable for installation at the master cylinder, in series or parallel on a brake line, or at the caliper/drum. If the brake modulation device is installed at the caliper, the device may either replace the existing banjo bolt, or may replace the bleeder valve. The brake modulation device may be installed anywhere in a vehicle's brake system that is in fluid communication with the brake fluid.

In a further embodiment, the present invention is used with hydraulic systems other than vehicle braking systems. For example, the present invention may be used with hydraulic operating systems on stationary or mobile machinery. Such a hydraulic fluid modulation device is integrated with the hydraulic operating system in a similar way as when integrated with vehicle braking systems.

### BRIEF DESCRIPTION OF THE DRAWINGS

The present invention can be more completely understood and appreciated by referring to the following more detailed description of the presently preferred exemplary embodiments of the invention in conjunction with the accompanying drawings, of which:

FIG. 1 is a cross-sectional view of an embodiment of a brake modulation device according to the present invention.

FIG. 1A is a cross-sectional view of another embodiment of a brake modulation device according to the present invention.

FIG. 2 is a cross-sectional view of another embodiment of a brake modulation device according to the present invention.

FIG. 3A is an elevational view of the embodiment depicted in FIG. 1.

FIG. 3B is an elevational view of the embodiment depicted in FIG. 1A.

FIG. 3C is an elevational view of a brake modulation device application according to the present invention.

FIG. 3D is an elevational view of a further brake modulation device application according to the present invention.

FIG. 4 is an elevational view of another brake modulation device application according to the present invention.

FIG. 5 is a perspective view of a brake modulation device according to the present invention.

### DETAILED DESCRIPTION OF THE DRAWINGS

In the following detailed description of the present invention, numerous specific details are set forth in order to provide a thorough understanding of the present invention. However, it will be apparent to one skilled in the art that the present invention may be practiced without these specific details. In other instances, well-known methods, procedures, and components have not been described in detail so as to not unnecessarily obscure aspects of the present invention.

In one embodiment, the present invention is intended for use with any vehicle utilizing a hydraulic braking system, such as but not limited to automobiles, trucks, motorcycles, all-terrain vehicles, tractors, heavy equipment, and the like.

Referring now generally to the Figures, a brake modulation device 20 is depicted. The device 20 generally comprises a housing 22, a cap 24, and a seal or diaphragm 26. Housing 22 includes an engagement portion 32, an internal bore 34, and a fluid reservoir 36. Engagement portion 32 is preferably threaded so as to be compatible with standard brake components on vehicles. Internal bore 34 begins at the proximate end 38 of the device, and extends up to fluid reservoir 36. Bore 34 provides fluid communication from reservoir 36 to any braking component in which device 20 is installed. At distal end 40 is the top of device 20 which is configured to receive cap 24. Housing 22 of device 20 may also include a hexagonal profile to facilitate installation with a wrench.

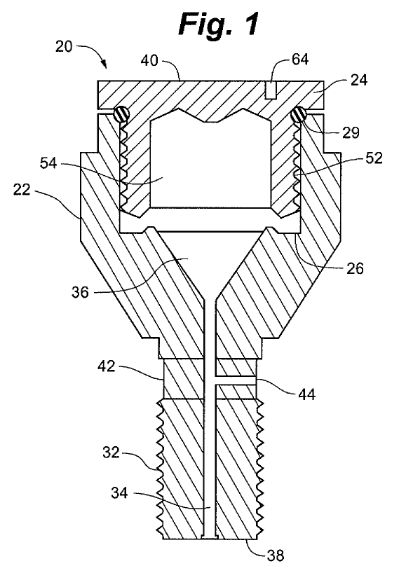

In one embodiment where brake modulation device 20 replaces a pre-existing banjo bolt on the brake system of a vehicle, housing 22 also includes a recessed area 42 to accept a banjo fitting, and a passageway 44 from recess 42 to internal bore 34, such as depicted in FIGS. 1, 1A, 2, and 3A. It should be noted that device 20 need not replace an existing banjo bolt in a vehicle brake system, rather the device need only be in fluid communication with the brake fluid in the vehicle's brake system.

Cap 24 is configured to be coupled to housing 22. In one embodiment depicted in the Figures, cap 24 includes a threaded portion 52 for coupling cap 24 to housing 22. A chamber 54 is defined within cap 24, wherein chamber 54 is configured to store a gas such as argon, nitrogen, air, or other suitable gases. In another embodiment not shown in the Figures, chamber 54 is defined within housing 22, rather than in cap 24.

Cap 24 may include a tamper-proof assembly hole 64 to insure the safety of the brake system is not compromised. A cap seal 29 may be included to seal cap 24 against housing 22. Cap seal 29 may also act to seal chamber 54.

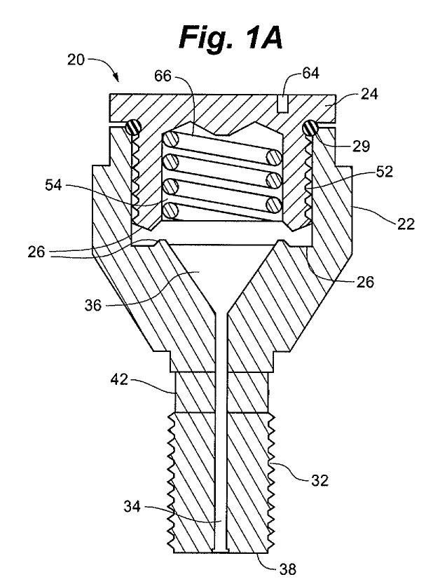

In one embodiment, brake modulation device 20 includes an adjustment mechanism 56. In one embodiment depicted in FIG. 2, adjustment mechanism 56 includes an adjustable set screw 58, a lock nut 60, and a seal 62. Set screw 58 is in communication with chamber 54, such that advancing set screw 58 into or out of chamber 54 adjusts the pressure of the gas within chamber 54, thereby adjusting the modulation effect of device 20. For example, by advancing set screw 58 into chamber 54, the volume of chamber 54 is reduced, thereby increasing the pressure of the gas contained within chamber 54. Conversely, by backing set screw 58 out of chamber 54, gas pressure within chamber 54 is reduced. Additionally, set screw 58 may be advanced proximate to, or against, diaphragm 26 in order to turn device 20 “off.” Lock nut 60 may be provided to maintain the position of set screw 58, and seal 62 is preferably included around set screw 58 to prevent leaks.

In one embodiment, device 20 includes a spring 66 within chamber 54. Spring 66 may be used in conjunction with, or independent of, pressurized gas within chamber 54. An adjustment mechanism 56 may be used in conjunction with spring 66 to preload spring 66.

Diaphragm or primary seal 26 is located between gas chamber 54 in cap 24 and fluid reservoir 36 in housing 22. Diaphragm 26 may comprise an elastomer, or other suitable material having a known deformation characteristic. Diaphragm 26 is secured within housing 22 by cap 24 being threaded down on to diaphragm 26, such as depicted in FIGS. 1 and 2. During operation, diaphragm 26 deforms or deflects to modulate the braking system of a vehicle in which device 20 is installed.

Referring now to installation of brake modulation device 20, a number of options exist. Because device 20 is relatively small in size, it is easily installed anywhere in a vehicle's brake system. For example, device 20 may be installed at the master cylinder, at the caliper, or anywhere in between. The device 20 need only be installed in fluid communication with the brake fluid in the vehicle's brake system.

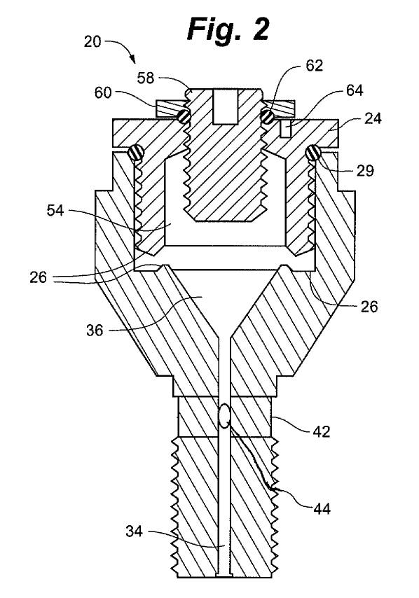

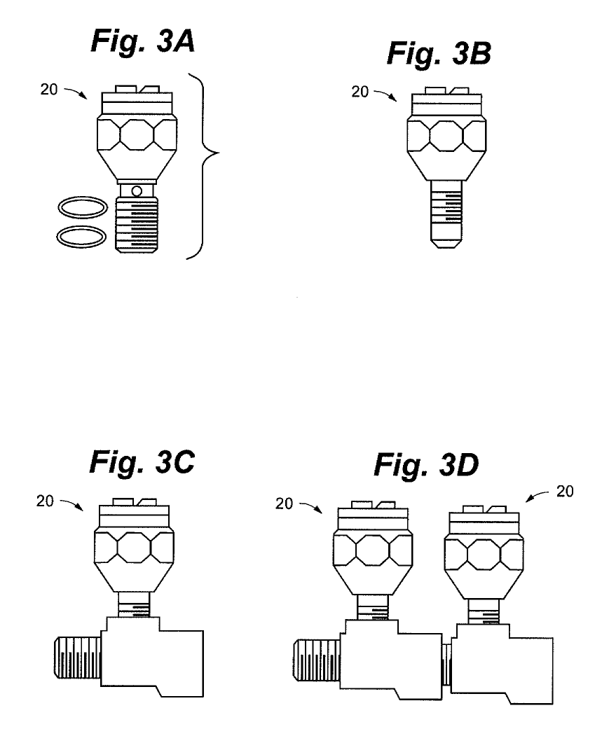

One installation method is to remove a pre-existing banjo bolt in a vehicle caliper, and replace it with device 20, such as depicted in FIG. 3A. The banjo fitting on the brake line of the vehicle is installed on housing 22 of device 20, around recess 42, and device 20 is tightened into the caliper. If the vehicle includes multiple calipers or drums, additional devices can be installed at each of the calipers or drums. A further installation method is to remove a pre-existing banjo bolt from the master cylinder, and replace it with device 20 such as depicted in FIG. 3A. In such an embodiment, device 20 may be configured to accept multiple banjo fittings, for instance when multiple brake lines are attached at the master cylinder. Multiple recessed areas 42 may be provided on housing 22 for this purpose. Another installation method is to remove a pre-existing bleeder screw from a caliper and replace it with device 20, such as depicted in FIG. 3B. A further installation method (not pictured), is to provide threads in a banjo fitting in the brake system of a vehicle and thread device 20 directly through the banjo fitting and into a caliper (or master cylinder, depending on application). A still further installation method (not pictured) is to integrate device 20 with existing brake system components, such as the master cylinder, caliper(s), or drum(s), during manufacturing of those components.

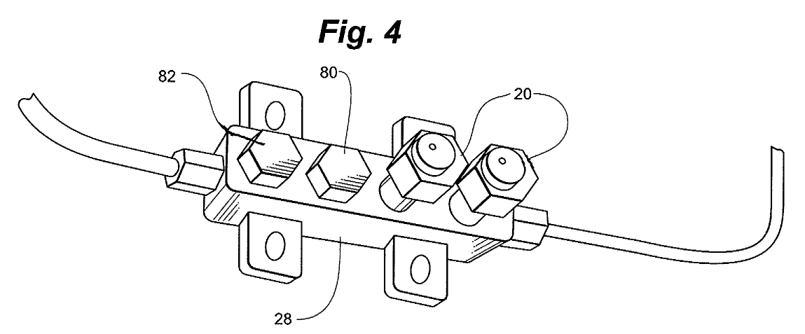

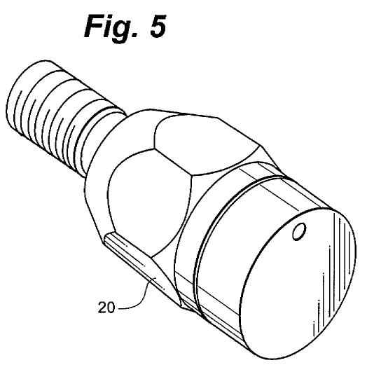

Additionally, device 20 may be installed in configurations such as depicted in FIGS. 3C, 3D, and 4. These configurations are in-line with the brake lines of a vehicle at any desired location within the vehicle brake system. As depicted in FIG. 4, a mounting block 28 may be provided, configured to receive multiple brake modulation devices 20. Bleeder valves 80 and/or plugs 82 may also be installed in mounting block 28.

Referring now to operation of brake modulation device 20, a vehicle brake system typically includes at least the following components: a master cylinder, one or more calipers/drums, brake lines, and fittings. When device 20 is installed and thereby fluidly integrated with the brake system of a vehicle, brake fluid is present in internal bore 34 and therefore fluid reservoir 36 of housing 22. As a user applies the brakes of a vehicle by stepping on a brake pedal or pulling a brake lever, brake fluid is moved from the master cylinder to the piston within the caliper/drum. Additionally, as a user applies the vehicle's brakes, brake fluid within the fluid reservoir may deform or deflect diaphragm 26, depending on the pressure applied by the user and the stiffness of diaphragm 26. Deflection of diaphragm 26 partially compresses the gas within the chamber 54.

While the user is applying the brakes, brake modulation device 20 provides a modulation feature to lessen the affect of various imperfections in the brake system of the vehicle. Such imperfections may be out of true rotors or drums, stuck caliper pistons, or a stuck floating caliper or rotor. Ordinarily, such imperfections in the brake system could lead to wheel lock-up, however, the present invention provides for continued braking performance and resists lock-up due to such imperfections. Additionally, adverse road conditions may contribute to wheel lock-up, such as sand, gravel, mud, or slick or icy roads. The adverse road condition may be uniform across the road surface such that all wheels of the vehicle are subject to the road condition, or may be on only part of the road surface, such that there may be a friction differential between one or more wheels of the vehicle.

If a pressure fluctuation or shock wave is introduced into the fluid of the brake system, such as by an out-of-true brake rotor, diaphragm 26 and gas chamber 54 are able to absorb some or all of the shock wave. Absorption of the pressure shock wave is handled by deflection of diaphragm 26 and compression of the gas within chamber 54, and an incidence of wheel lock-up is thereby reduced. Brake modulation device 20 may perform as a spring, damper, dashpot, shock absorber, or damped spring, depending on the desired and selected characteristics of the diaphragm 26 and the gas within chamber 54.

The amount of modulation provided by device 20 may be adjusted by modifying one or more characteristics of diaphragm 26, such as the thickness of diaphragm 26, the durometer reading of the material, or the material used. The amount of modulation may also be adjusted by modifying the pressure of the gas within chamber 54, as well as the size of chamber 54. As mentioned above, an adjustment mechanism 56 may be included with device 20, wherein the pressure of the gas within the chamber varies in relation to the setting of adjustment mechanism 56. In an embodiment where spring 66 is included in device 20, the spring constant of spring 66 may be adjusted to control the modulation of device 20. Device 20 may even be turned off—by completely advancing set screw 58 into diaphragm 26, movement of diaphragm 26 is eliminated, thereby removing from the vehicle brake system any modulation effect provided by device 20.

The brake modulation device may be used with conventional hydraulic brake systems, and may be used in conjunction with electronic anti-lock brake systems. The brake modulation device may have different characteristics for different vehicles. For example, vehicles of heavy weight will likely use a stiffer diaphragm than will be used on a vehicle of light weight. Additionally, it may be desirable on the front of a vehicle to use a stiffer diaphragm than on the rear of the vehicle, as the majority of a vehicle's stopping power is provided by the brakes on the front of the vehicle.

Although the present invention is described in one embodiment as a brake modulation device, it will be appreciated by one skilled in the art that other embodiments and applications exist for the device. For example, the present invention is readily adaptable for use with hydraulic machinery or hydrostatic drive systems, such as may be found on forklifts, heavy equipment, construction equipment, tractors, turf care equipment, and so forth. The present invention is also suitable for use with non-vehicular hydraulic systems, such as stationary machinery, manufacturing equipment, robotics, and so forth. Hydraulic systems as discussed in this paragraph may experience pressure fluctuations, spikes, surges, or waves, similar to the pressure fluctuations previously discussed herein in relation to vehicle brake systems. As such, the addition of the present invention to any hydraulic operating system results in smoother operation of the hydraulic system by eliminating or reducing the magnitude of pressure fluctuations occurring within the system.

The above disclosure is not intended as limiting. Those skilled in the art will readily observe that numerous modifications and alterations of the device may be made while retaining the teachings of the invention. Accordingly, the above disclosure should be construed as limited only by the restrictions of the appended claims.

What is claimed is:

1. A brake modulation device, comprising:
a fluid reservoir adapted to be in communication with fluid in a brake system of a vehicle;
a sealed chamber; and
a diaphragm separating the fluid reservoir and the chamber, the diaphragm adapted to deform under pressure from hydraulic fluid in the fluid reservoir.

2. The device of claim 1, further comprising an adjustment mechanism adapted to adjust one or more modulation characteristics of the device.

3. The device of claim 1, wherein the sealed chamber comprises pressurized gas.

4. The device of claim 1, wherein the sealed chamber includes a spring.

5. A method of modulating a vehicle hydraulic brake system, comprising:
providing a modulation device, including:
a fluid reservoir;
a sealed chamber; and
a diaphragm separating the fluid reservoir and the chamber;
installing the device such that the fluid reservoir is in communication with fluid in the vehicle hydraulic brake system; and
applying a brake pedal to create pressure in the vehicle hydraulic brake system, wherein the diaphragm is deformed under the pressure.

6. The method of claim 5, wherein the sealed chamber includes a pressurized gas and the gas is at least partially compressed from the diaphragm being deformed.

7. The method of claim 5, wherein the sealed chamber includes a spring, and the spring is at least partially compressed from the diaphragm being deformed.

8. The method of claim 5 wherein the modulation device further includes an adjustment mechanism, the method further comprising:
using the adjustment mechanism to modify one or more modulating characteristics of the brake device.

9. A hydraulic fluid modulation device for use in a hydraulic operating system, comprising:
a fluid reservoir adapted to be in communication with hydraulic fluid in the system;
a sealed chamber; and
a diaphragm separating the fluid reservoir and the chamber, the diaphragm adapted to deform under pressure from hydraulic fluid in the fluid reservoir.

10. The device of claim 9, wherein the sealed chamber comprises pressurized gas.

11. The device of claim 9, wherein the sealed chamber includes a spring.

12. The device of claim 9, further comprising an adjustment mechanism adapted to adjust one or more modulation characteristics of the device.

13. A brake system for a vehicle, comprising:
a master cylinder;
a brake caliper;
a brake line coupling the caliper to the master cylinder; and
a brake modulation device fluidly integrated with the vehicle brake system, including:
a fluid reservoir;
a sealed chamber; and
a diaphragm separating the fluid reservoir and the chamber, wherein the fluid reservoir is in fluid communication with a brake system of a vehicle.

14. The system of claim 13, wherein the sealed chamber comprises pressurized gas.

15. The system of claim 13, wherein the sealed chamber includes a spring.

16. The system of claim 13, further comprising an adjustment mechanism adapted to adjust one or more modulation characteristics of the device.
